(19) United States
(12) Patent Application Publication
(10) Pub. No.: US 2025/0052599 A1
(43) Pub. Date: Feb. 13, 2025

(54) GAS BASED FLOW SENSOR

(71) Applicant: CSEM CENTRE SUISSE D'ELECTRONIQUE ET DE MICROTECHNIQUE SA - RECHERCHE ET DEVELOPPEMENT, Neuchâtel (CH)

(72) Inventors: Marc FAVROD-COUNE, Bulle (CH); Noa SCHMID, Alpnach (CH); Jonas GOLDOWSKY, Ebikon (CH)

(21) Appl. No.: 18/719,907

(22) PCT Filed: Dec. 16, 2022
(86) PCT No.: PCT/EP2022/086413

§ 371 Date: Jun. 14, 2024

(30) Foreign Application Priority Data
Dec. 17, 2021 (CH) CH070739/2021

(51) Int. Cl. G01F 1/36; G01F 15/00

(52) U.S. Cl. CPC G01F 1/36; G01F 15/005

(57) ABSTRACT

An apparatus and method for metered continuous volumetric dispensing of a liquid fluid or metered dispensing of drop volumes. The apparatus includes a pressure control unit and a gas supply. The pressure control unit includes an input fluidically coupled with the gas supply and an output fluidically coupled with an inlet port of a container. The pressure control unit further includes a first restriction fluidically arranged between the input and the output and a first differential pressure sensor for measuring a pressure difference over the first restriction and the output. The pressure control unit further includes a bypass line with a bypass valve, configured to be open or to be closed, having a first end connected to the input and a second end connected to the output. The bypass line provides a direct fluidic connection between the input and the output, when the bypass valve is open.

### FIELD OF THE INVENTION

The present invention relates to an apparatus for metered continuous volumetric dispensing of a liquid fluid. Further the invention relates to a method for metered continuous dispensing of a liquid fluid, for example for metered dispensing of continuous strand extrusion. Further the invention relates to an apparatus and a method for metered dispensing drop volumes of a liquid fluid. Further the invention, relates to a method for determining by an apparatus according to the invention an initial gas volume which is present in a container prior to executing, the method for metered continuous volumetric dispensing of a liquid or the method for metered dispensing drop volumes of a liquid fluid.

### BACKGROUND OF THE INVENTION

Fluid dispensing is a critical process in a broad range of applications. Not only in medical and biomedical fields, but also in many industrial applications precise amounts of liquid have to be dispensed. Hence a large number of principles have been found, addressing the needs of the individual applications. An industrially widely used dispensing approach is “Time Pressure Dispensing” (TPD). TPD is a method of dispensing liquid materials that uses air pressure applied to the top of a syringe to force material through a needle. The amount of time the air pressure is applied is directly related to the amount of adhesive liquid dispensed. Common time pressure dispensing setups are easily implemented. However, TPD allows no feedback of the amount of liquid dispensed during the dispensing cycle. Especially syringe fill-level, viscosity of the medium, syringe to syringe variation and clogging are influencing the amount of liquid dispensed.

In biomedical and laboratory applications most often volume defined pumps are used. Syringe pumps allow precise dispensing of small volumes. However, they are expensive and bulky. Furthermore, syringe pumps suffer the challenge, to fill a syringe with mid to high viscosity materials without introducing air bubble. Air bubbles critically render a syringe pump system non-volumetric.

Alternatively, peristaltic pumps, smaller and lower in cost, can be used which create a pulsating flow, but this can be problematic in many applications. Generally, all pumping mechanisms can be used and observed with a flowmeter within the liquid path. However, the flowmeter itself often has to be calibrated with the media physical properties such as viscosity.

In general, a variety of methods are known for sensing flows. One can distinguish between material dependent flow meters, but there are also methods which are based on mechanical measurement, such as propellers or methods utilizing the Bernoulli-principle.

Two patent documents may be mentioned here, as representative of the state of the art, EP3043156 A1 and EP3376182 A1. EP3043156 A1 relates to an apparatus for dispensing and/or aspirating a predetermined volume of fluid from a chamber. The apparatus comprises a controllable valve connectable with a lower portion of the chamber, a pressure sensor arranged to be in fluid communication with the upper portion of the chamber and a pump, which is adapted to be in fluid communication between a source of gas and the upper portion of the chamber. A controller is also provided. It is in operative connection with the controllable valve, the pressure sensor and the pump.

Furthermore, in EP3043156 A1 an apparatus is proposed, which is particularly adapted to aspirate or dispense a desired quantity of fluid without requiring a priori knowledge of the volume of the chamber or the volume of fluid in the chamber.

EP3376182 A1 provides a liquid fluid dispensing or aspirating apparatus and a method for dispensing or aspirating metered controlled amounts of a liquid with a compressible gas, relying on the recovery of an internal pressure of the compressible gas towards the externally applied pressure and the gas flow caused thereby through a flow sensing assembly. According to EP3376182 A1 dispensing and aspiration of liquids, independent of the liquids viscosity, is performed.

### SUMMARY OF THE INVENTION

An object of the present invention is to provide an apparatus, a method for metered continuous volumetric dispensing of a liquid fluid, for example of continuous strand extrusion, a method and an apparatus for metered dispensing drop volumes of a liquid fluid and a method for determining by an apparatus according to the invention an initial gas volume which is present in a container prior to executing the method for metered continuous dispensing of a liquid fluid or for metered dispensing drop volumes of a liquid fluid.

The object is solved by the entirety of the features of the claims.

The terms “fluidically coupled” and “liquid fluid” used in the application shall be understood as follows:

By “fluidically coupled” a gas and/or liquid pathway being present between the components mentioned should be understood.

“Liquid fluid” should be understood in a broad manner, also covering viscous fluids, Newtonian fluids as well as non-Newtonian fluids, e.g. fluids with thixotropic characteristics. Further covered by the term “liquid fluid” are liquids or viscous fluids comprising particles, for example nano-, and micro particles of inert and solid materials (such as glass spheres, metallic flakes), cells or other bioactive molecules.

The apparatus according to the invention is for metered continuous volumetric dispensing of a liquid fluid, for example continuous strands or for metered dispensing drop volumes of a liquid fluid. The apparatus comprises a pressure control unit and a gas supply. The gas supply provides a controllable gas stream. The pressure control unit comprises an input and an output, wherein the input is configured to be fluidically coupled with the gas supply and wherein the output is configured to be fluidically coupled with an inlet port of a container. The pressure control unit further comprises a first restriction, which is fluidically arranged between the input and the output. The pressure control unit further comprises at least one first differential pressure sensor for measuring a pressure difference over the first restriction and the output as well as a bypass line with a bypass valve. The bypass valve is configured to be open or to be closed, wherein the bypass line has a first end connected to the input and a second end connected to the output. The bypass line is configured to provide a direct fluidic connection between the input and the output, when the bypass valve is open.

In particular, for metered continuous volumetric dispensing, such as for continuous strand dispensing, the bypass line with the bypass valve enable to accelerate the introduction of a gas stream into the container.

A precise measurement over time and over a wide range of flow rates is possible. The invention is configurable to operate in highly dynamic start and stop behavior, by a clearly defined and optimized sequence of valve operations. The measurement can take place in a rapid manner, allowing for quick reaction and enabling closed loop dispensing control.

Further the apparatus as well as the method according to the inventions provides a contactless measurement principle. There are no sensors, which are in direct contact with dispensed liquid and thus no contamination or clogging by the medium takes place.

The apparatus is independent of the container system and tubing. In a preferred embodiment, the container is a cartridge containing the liquid fluid to be dispensed.

In a preferred embodiment according to the invention piezo resistive pressure sensor in the range 1 mbar to 500 mbar, preferably between 1.6 mbar to 160 mbar.

In a first embodiment of the apparatus according to the invention, the pressure control unit comprises a housing providing an internal space. In a preferred embodiment of the first embodiment the internal space is designed to be gas-tight.

The gas tight housing is designed to sustain the maximal pressure of the machine 10 bars.

The pressure control unit comprises a second restriction, which is fluidically arranged between the input and the output. An outlet of the first restriction and an inlet of the second restriction are configured to be fluidically coupled to the internal space of the housing. A first port of the first differential pressure sensor is fluidically coupled to an inlet of the first restriction and a second port of the first differential pressure sensor is fluidically coupled to the internal space of the housing. The pressure control unit comprises a second differential pressure sensor, wherein a first port of the second differential pressure sensor is fluidically coupled to an outlet of the second restriction and a second port of the second differential pressure sensor is fluidically coupled to the internal space of the housing.

In a preferred embodiment the first restriction has a diameter of 0.5 mm and a length of 25 mm. The second restriction has a smaller diameter than the first restriction, preferably 0.1 mm.

The advantage of the two restrictions is that the range of measurement can be increased.

As the restrictions are fluidically coupled with one end to the internal space of the housing, it is possible to easily replace the restriction in case a measuring of another flow rate is required.

The first and second differential pressure sensors may have different measurement ranges. In an exemplary embodiment according to the invention piezo resistive pressure sensor in the range of 1.6 mbar to 160 mbar are used.

An advantage of the apparatus according to the invention is that due to the possible replacement of the restrictions or due to the addition of additional differential pressure sensors the measuring range with regard to the flow rate can be easily adjusted. Due to the implementation of the second differential pressure sensor the preciseness of the pressure measurement is further increased.

The first embodiment of the apparatus according to the invention further comprises a vent valve, which is fluidically coupled with the first end to the internal space of the housing and with the second end to the surrounding atmosphere. Preferably the second end is fluidically coupled to a vent silencer.

In addition, or as an alternative the vent valve is also configured to be coupled to the container and to the surrounding atmosphere. The apparatus comprising an additional flow channel for coupling the vent valve with the container, whereby said flow channel bypasses the outlet.

In a second embodiment of the apparatus according to the invention, a first port of the first differential pressure sensor is fluidically coupled to an inlet of the first restriction and a second port of the first differential pressure sensor is fluidically coupled to an outlet. In this embodiment the pressure control unit further comprises a second differential pressure sensor. The second differential pressure sensor is fluidically arranged in parallel to the first differential pressure sensor. The first and second differential pressure sensor have different measurement ranges. In an exemplary embodiment according to the invention piezo resistive pressure sensors in the range of 1.6 mbar to 160 mbar are used.

The pressure control unit of the second embodiment comprises one restriction, which is fluidically arranged between the input and the output.

Regardless of whether first or second embodiment of the apparatus, the pressure control unit comprises an input port for fluidically coupling the pressure control unit with the gas supply and comprises an output port for fluidically coupling the pressure control unit with the container, for example with an inlet port of the container.

The input port can be configured to be the input valve. The output port can be configured to be the output valve.

Regardless of whether first or second embodiment of the apparatus, the pressure control unit further comprises an absolute pressure sensor for measuring the absolute pressure in the pressure control unit.

The container for carrying a liquid has an outlet port, preferably the outlet port is coupled to a needle or a dosing valve.

Downstream the container further sensors or actuators can be arranged. In this sense the outlet port can be coupled, for example to a tubing or a micro fluidic chip.

In a preferred embodiment the outlet port of the container is fluidically coupled to a tubing.

The apparatus according to the invention is configured for metered continuous volumetric dispensing of a liquid fluid or for metered dispensing drop volumes of a liquid fluid.

A method for metered continuous volumetric dispensing of a liquid fluid, for example continuous strands, with an apparatus according to the invention comprises the following steps:
i. setting a dispensing pressure at the gas supply,
ii. opening the input, the output, and the bypass valve,
iii. continuously evaluating the absolute pressure sensor or the differential pressure sensors until a stable value is reached,
iv. closing of the bypass valve,
v. continuously measuring of the pressure difference over the first restriction or over the first and second restriction by evaluating the first and second differential pressure sensor, thereby determining a flow of liquid fluid exiting the container and being dispensed,
vi. closing the input upon an end-of-dispensing condition being met, the end-of-dispensing condition being in particular a pre-determined amount of liquid fluid being dispensed and/or a pre-determined dispensing time being reached.

A further option for an end-of-dispensing condition is dependent from a position, for example from a position of a robot.

The steps as mentioned above can be performed one after the other. However, individual steps can also be executed in parallel. The preceding list (i.-vi.) is not necessarily chronological.

According to one variant of the method for metered continuous volumetric dispensing of a liquid fluid, the container and/or the internal space of the gas-tight housing is vented, after the pre-determined target, e.g. a pre-determined amount of liquid fluid is dispensed or a certain pre-determined time period is expired, is achieved.

Venting of the internal space of the gas tight housing takes place by opening the output and a vent valve. The vent valve is fluidically coupled to the internal space of the housing with one end and to the surrounding atmosphere with the second end.

Venting of the container takes place by opening a vent valve which is fluidically coupled to the container with one end, preferably, via an additional flow channel and with the second end to the surrounding atmosphere.

A method for metered dispensing drop volumes of a liquid with an apparatus according to the invention comprises the following steps:
i. setting a starting pressure at the gas supply,
ii. opening the input and the output with the bypass valve being closed,
iii. continuously evaluating the absolute pressure sensor and the differential pressure sensors until a stable value is reached,
iv. calculating the amount of gas within system and cartridge,
v. closing the output,
vi. dispensing of liquid fluid as droplets by repeatedly opening and closing of the dosing valve and continuously evaluating the differential pressure sensors until a pre-determined amount of droplets are dispensed and/or a pre-determined differential pressure is measured by the differential pressure sensors.

The steps as mentioned above can be performed one after the other. However, individual steps can also be executed in parallel. The preceding list (i.-vi.) is not necessarily chronological.

According to one variant of the method for metered dispensing drop volumes of a liquid, the container and/or the internal space of the gas-tight housing is vented, after the pre-determined target, e.g. a pre-determined amount of droplets is dispensed and/or a pre-determined differential pressure is measured by the differential pressure sensors.

Venting of the internal space of the gas tight housing takes place by opening the output and a vent valve. The vent valve is fluidically coupled to the internal space of the housing with one end and to the surrounding atmosphere with the second end.

Venting of the container takes place by opening a vent valve which is fluidically coupled to the container with one end, preferably, via an additional flow channel and with the second end to the surrounding atmosphere.

In the embodiment, where the apparatus according to the invention does not comprise a gas tight housing, venting takes place by opening the bypass valve, the output and the input.

Further a method for determining an initial gas volume which is present in the container prior to executing the method is suggested.

Said method is performed by the apparatus according to the invention and includes the following steps:
i. if there is a dosing valve at the outlet port of the container is provided, closing of the dosing valve,
ii. setting of an auxiliary pressure at the gas supply, the auxiliary pressure being defined by a gas volume determination pressure reduced by a maximum measuring pressure measurable by the differential pressure sensors,
iii. opening of the input, the output, and preferably the bypass valve, and continuously evaluating the absolute pressure sensor or the differential pressure sensors until a stable value for auxiliary pressure is reached,
iv. if applicable, closing the bypass valve
v. setting the gas volume determination pressure at the gas supply,
vi. recording of a measurement of an absolute pressure on absolute pressure sensor and a differential pressure over the first restriction or the first and the second restriction on the first and the second differential pressure sensor as function of time,
vii. computing the initial gas volume based on the recorded measurements of the absolute pressure and the differential pressure over the first restriction or the first and the second restriction on the first and the second differential pressure sensor.

The steps as mentioned above can be performed on after the other. However, individual steps can also be executed in parallel. The preceding list (i.-vii.) is not necessarily chronological.

With respect to the determination of an initial gas volume of the container prior to executing the method according to the invention, reference is made to EP30743156A1, in particular et seq. Said document is therewith incorporated by reference.

With respect to the method for determining an initial gas volume which is present in the container reference is made to EP30743156A1, in particular et seq. of said document is therewith incorporated by reference.

### BRIEF DESCRIPTION OF THE DRAWINGS

The herein described invention will be more fully understood from the detailed description given herein below and the accompanying drawings which should not be considered limiting to the invention described in the appended claims. The drawings are showing:

FIG. 1 shows a first embodiment of the invention, a flow sheet of the apparatus according to a gas tight embodiment having a gas tight housing;

FIG. 2(a) shows the flow sheet of FIG. 1 representing the gas flow as well as the open or closed state of the valves prior to droplet dispensing;

FIG. 2(b) shows the flow sheet of FIG. 1 representing the gas flow as well as the open or closed state of the valves during droplet dispensing;

FIG. 3(a) shows the flow sheet of FIG. 1 representing the gas flow as well as the open or closed state of the valves prior to metered continuous volumetric dispensing of a liquid fluid, for example strand dispensing;

FIG. 3(b) shows the flow sheet of FIG. 1 representing the gas flow as well as the open or closed state of the valves during metered continuous volumetric dispensing of a liquid fluid, for example strand dispensing;

FIG. 3(c) shows the flow sheet of FIG. 1 representing the gas flow as well as the open or closed state of the valves after metered continuous volumetric dispensing of a liquid fluid, for example strand dispensing;

FIG. 4 shows a second embodiment with respect to the invention, a flow sheet of the apparatus according to a non-gas tight embodiment with no housing;

FIG. 5(a) shows the flow sheet of FIG. 4 representing the gas flow as well as the open or closed state of the valves prior to droplet dispensing;

FIG. 5(b) shows the flow sheet of FIG. 4 representing the gas flow as well as the open or closed state of the valves during droplet dispensing;

FIG. 6(a) shows the flow sheet of FIG. 4 representing the gas flow as well as the open or closed state of the valves prior to metered continuous volumetric dispensing of a liquid fluid, for example strand dispensing;

FIG. 6(b) shows the flow sheet of FIG. 4 representing the gas flow as well as the open or closed state of the valves during metered continuous volumetric dispensing of a liquid fluid, for example strand dispensing;

FIG. 6(c) shows the flow sheet of FIG. 4 representing the gas flow as well as the open or closed state of the valves after metered continuous volumetric dispensing of a liquid fluid, for example strand dispensing.

### DESCRIPTION OF THE EMBODIMENTS

Reference will now be made in detail to certain embodiments, examples of which are illustrated in the accompanying drawings, in which some, but not all features are shown. Indeed, embodiments disclosed herein may be embodied in many different forms and should not be construed as limited to the embodiments set forth herein; rather, these embodiments are provided so that this disclosure will satisfy applicable legal requirements. Whenever possible, like reference numbers will be used to refer to like components or parts.

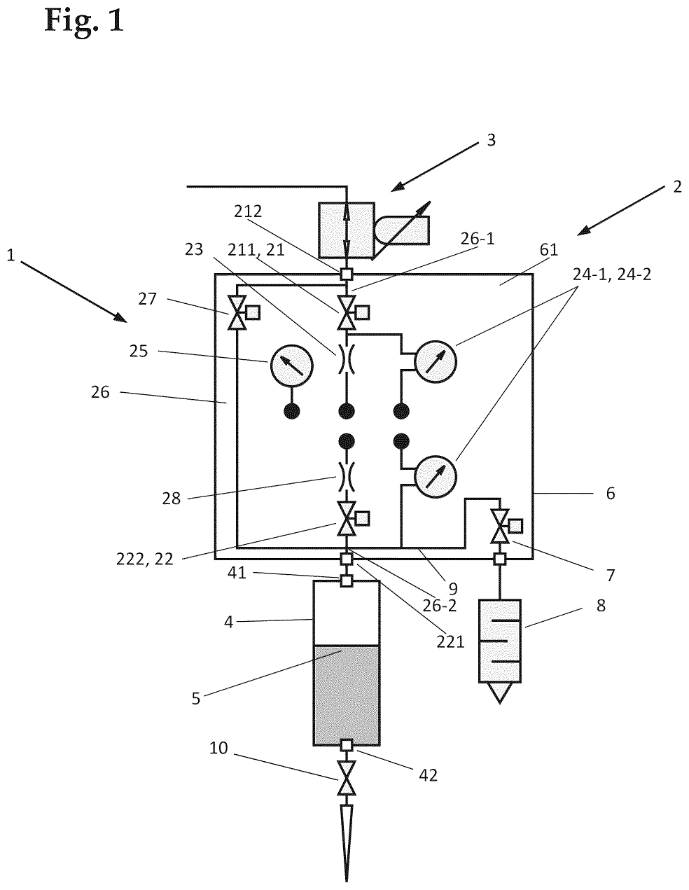

FIG. 1 shows a first embodiment of the apparatus 1 according to the invention. The apparatus comprises a pressure control unit 2 with three pressure sensors 24-1, 24-2 and 25. Two pressure sensors 24-1 and 24-2 are differential pressure sensors. The pressure sensor 25 is an absolute pressure sensor. The pressure control unit 2 has an input 21, preferably comprising an input valve 211 and/or an input port 212. In the embodiment shown in FIG. 1 the input 21 comprises an input valve 211 and an input port 212. The pressure control unit 2 has an output 22, preferably comprising an output valve 222 and/or an output port 221. In the embodiment shown in FIG. 1 the output 22 comprises an output valve 222 and an output port 221.

In the embodiment shown in FIG. 1 the outlet port 221 is in fluid communication with an inlet port 41 of the container 4.

The input 21 is used to connect the apparatus 1 fluidically to a gas supply 3 and the output 22 to measure liquid volumes to be dispensed. The embodiment according to FIG. 1 further comprises two restrictions 23, 28 with different dimensions. The first restriction 23 is a so-called “weak flow restriction” and the second restriction a so-called “strong flow restriction”. The dimensions of the weak flow restriction is for example Ø 0.5 mm×25 mm and for the strong flow restriction for example Ø 0.1 mm×25 mm.

Both restrictions are arranged between the input 21 and the output 22. The pressure control unit 2 of the embodiment of FIG. 1 further comprises a bypass line 26 with a bypass valve 27. The bypass line 26 has a first end 26-1 connected to the input 21 and a second end 26-2 connected to the output 22.

The embodiment shown in FIG. 1 comprises a housing 6 with an internal space 61. The housing 6 is gas tight. According to the embodiment of FIG. 1 the three sensors 24-1, 24-2, 25, the two restrictions 23 and 28 and the output valve 222 are arranged inside the gas-tight housing 6. The input valve 211, the bypass valve 27, and the vent valve 7 are are arranged outside the housing but fluidically connected to the inside of the housing 6 (not visible in FIG. 1).

As it can be seen in FIG. 1 a first port of the first differential pressure sensor 24-1 is fluidically coupled to the inlet of the first restriction 23. A second port of the first differential pressure sensor 24-1 is fluidically coupled to the internal space 61 of the housing 6. A first port of the second differential pressure sensor 24-2 is fluidically coupled to an outlet of the second restriction 28 and a second port of the second differential pressure sensor 24-2 is fluidically coupled to the internal space 61 of the housing 6. A vent valve 7 is coupled to the surrounding atmosphere. In the embodiment shown in FIG. 1 the first port of the vent valve 7 is connected to a vent silencer 8.

Further shown in FIG. 1 is an additional flow channel 9. Said channel 9 provides a fluidic connection between a container 4 and the vent valve 7.

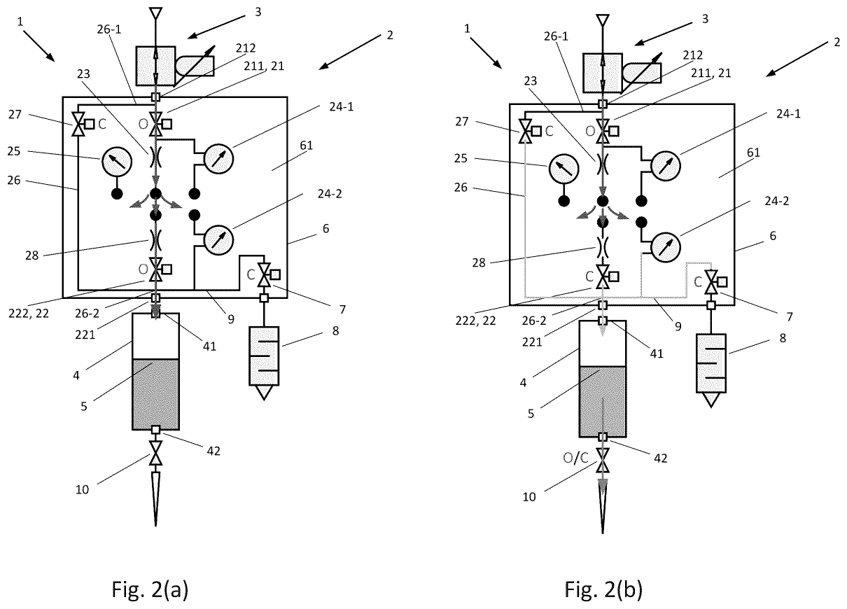

In FIG. 2(a) the gas flow as well as the open or closed state (marked with “c” for closed state and marked with “o” for open state) of the bypass valve 27, the input 21, e.g. an input valve 211 and the output 22, e.g. an output valve 222 prior to droplet dispensing is shown. FIG. 2(a) is based on the embodiment represented in FIG. 1. Same features are named with same reference numbers. As it can be schematically seen, the pressure control unit 2 is fluidically coupled to the gas supply 3 via an inlet port 212 and to the inlet port 41 of a container 4 comprising a liquid fluid 5, for example an inject for printing, via an outlet port 221. According to FIG. 2(a) the bypass valve 27 and the vent valve 7 are closed. For dispensing droplets an outlet port 42 of the container 4 comprises a dosing valve 10. Prior droplet dispensing starts, the dosing valve 10 is closed. The input 21 as well as the output 22 are open and the bypass valve 27 and the vent valve 7 are closed. The absolute pressure sensor 25 and the differential pressure sensors 24-1, 24-2 are continuously evaluated until a stable value is reached.

In FIG. 2(b) the gas flow as well as the open or closed state of the bypass valve 27, the input 21, e.g. an input valve 211 and the output 22, e.g. an output valve 222 during droplet dispensing is shown. During droplet dispensing the output valve 22, the bypass 27 as well as the vent valve 7 are closed. No further gas enters the container 4. By repeatedly opening and closing the dosing valve 10, droplets are ejected from container 4. Further the differential pressure sensors 24-1, 24-2 are continuously evaluated until a pre-determined amount of droplets are dispensed and/or a pre-determined differential pressure is measured by the differential pressure sensors 24-1, 24-2.

As shown in FIG. 1 and FIG. 2(a) and FIG. 2(b) the container 4 comprises an inlet port 41 and an outlet port 42. The container 4 is fluidically coupled to the pressure control unit 2 via the inlet port and the output port 221 of the pressure control unit 2.

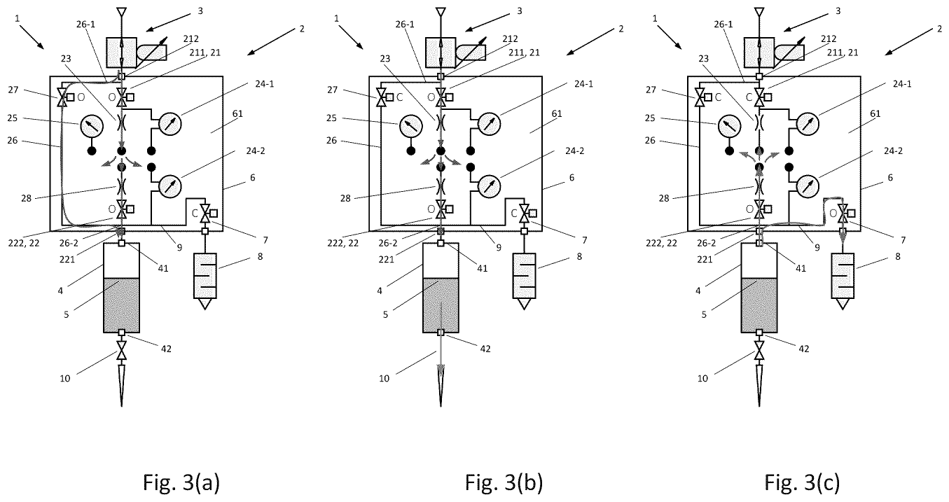

In FIG. 3(a) the gas flow as well as the open or closed state (marked with “c” for closed state and marked with “o” for open state) of the bypass valve 27, the input 21, e.g. an input valve 211 and the output 22, e.g. an output valve 222 prior to, metered continuous volumetric dispensing of a liquid fluid, for example strand dispensing are shown. For metered continuous volumetric dispensing of a liquid fluid, for example strand dispensing, a dispensing pressure is set at the gas supply 3. Compared to droplet dispensing as shown in the previous FIGS. 2(a), (b) the outlet port 42 of the container 4 does not comprise a dosing valve 10. Prior to metered continuous volumetric dispensing of a liquid fluid, for example strand dispensing the bypass line 26 is activated by opening the bypass valve 27. Further open is the input 21 and the output 22 and the outlet port 42. In case a dosing valve 10 is presents, it will be open as well. The vent valve 7 is closed. The absolute pressure sensor 25 or the differential pressure sensors 24-1, 24-2 are continuously evaluated until a stable value is reached.

In FIG. 3(b) the gas flow as well as the open or closed state (marked with “c” for closed state and marked with “o” for open state) of the bypass valve 27, the input 21, e.g. an input valve 211 and the output 22, e.g. an output valve 222 during metered continuous volumetric dispensing of a liquid fluid, for example strand dispensing are shown. During metered continuous volumetric dispensing of a liquid fluid, for example strand dispensing the bypass valve 27 is closed. The input and the output 21, 22 are open and the vent valve 7 is closed. Before the bypass valve 27 is closed, the absolute pressure sensor 25 or the differential pressure sensors 24-1, 24-2 are continuously evaluated until a stable value is reached. During metered continuous volumetric dispensing of a liquid fluid, the pressure difference over the first 23 and second 28 restrictions is continuously measured by evaluating the first 24-1 and second 24-2 differential pressure sensor, thereby determining a flow of liquid fluid exiting the container 4 and being dispensed.

FIG. 3(c) shows the gas flow as well as the open or closed state (marked with “c” for closed state and marked with “o” for open state) of the bypass valve 27, the input 21, e.g. an input valve 211 and the output 22, e.g. an output valve 222 after metered continuous volumetric dispensing of a liquid fluid, such as strands.

The input 21, more particular the input valve 211, is closed upon a pre-determined target is achieved, for example a pre-determined amount of liquid fluid has been dispensed or a certain pre-determined time period has been expired.

In FIG. 3(c) there are options shown how the pressure control unit 2, more particular, the internal space 61 of the gas-tight housing 6 and/or the container 4 is vented.

During venting the output 22, for example the output valve 222 and the vent valve 7 are opened. In the embodiment shown in FIG. 3(c) the end of the vent valve 7 which is fluidically coupled to the surrounding atmosphere is coupled with a vent silencer 8.

Venting of the container takes place by opening a vent valve 7, which is fluidically coupled to the container 4 with one end, preferably, via an additional flow channel 9 and with the second end to the surrounding atmosphere.

In the embodiment shown in FIG. 1 the outlet port 221 is in fluid communication with an inlet port 41 of the container 4.

Venting of the container 4, which is fluidically coupled via the inlet port 41 and the outlet port 221 to the pressure control unit takes place by opening the output 22, via the second restriction 28. The inlet of the second restriction 28 is fluidically coupled to the internal space 61 of the housing 6.

Venting can also take place after metered dispensing of drop volumes as shown FIG. 2(b).

FIG. 3(a), 3(b), 3(c) are based on the embodiment represented in FIG. 1. Same features are named with same reference numbers

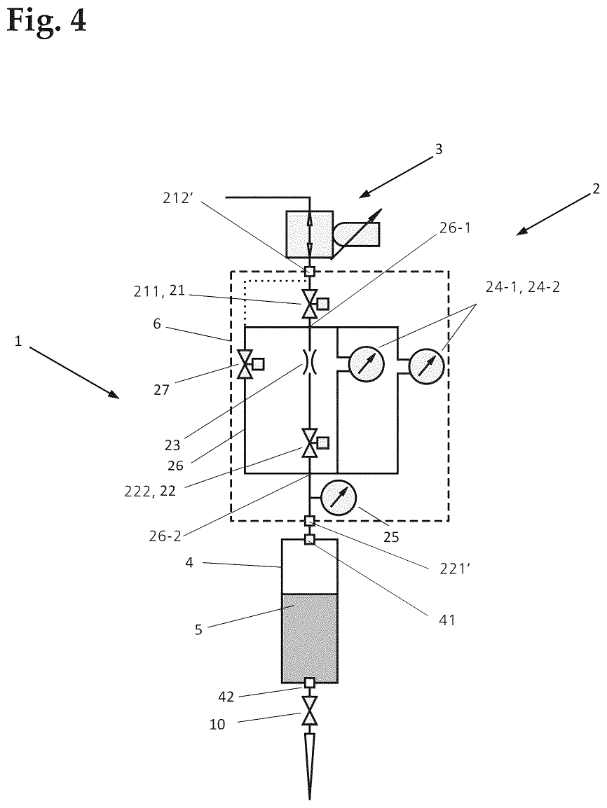

In FIG. 4 a second embodiment of the invention is shown. Compared to the first embodiment the pressure control unit 2 only comprises one restriction 23. The second embodiment of the apparatus 1 has two differential pressures sensors 24-1, 24-2 and one absolute pressure sensor 25. As in the first embodiment the pressure control unit 2 comprises an input 21 and an output 22 as well as a bypass line 26 with a bypass valve 27.

The pressure control unit 2 is fluidically coupled to the gas supply 3 via an inlet port 212′ and to the inlet port 41 of the container 4 comprising a liquid fluid 5, for example an inject for printing, via an outlet port 221′. The container 4 has an outlet port 42. In the embodiment of FIG. 4 the outlet port comprises a dosing valve 10.

The first and the second differential pressure sensors 24-1, 24-2 are both fluidically coupled to an inlet of the restriction 23 and a second port of the first differential pressure sensor 24-1, 24-2 is fluidically coupled to an outlet of the output 22. The first and the second differential pressure sensors 24-1, 24-2 are fluidically arranged in parallel.

The bypass line 26 has a first end 26-1 connected to the input 21 and a second end 26-2 connected to the output 22.

In a further embodiment of the embodiment not shown in FIG. 4 at least the pressure sensors 24-1, 24-2 and 25 as well as the input 21, e.g. an input valve 211 the output 22, e.g. an output valve 222 and the bypass line 26 with the bypass valve 27 as well as the restriction 23 are covered by a gas tight housing.

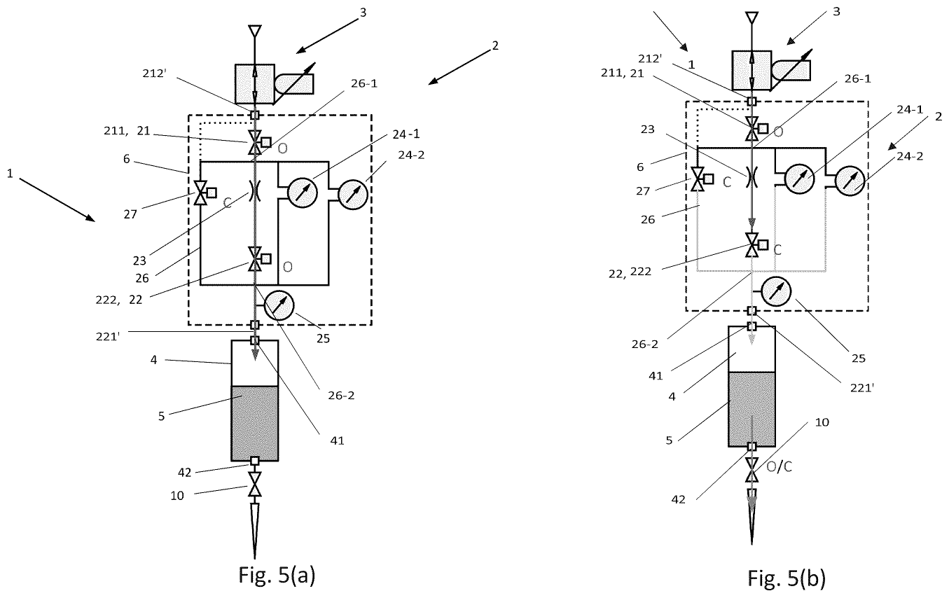

In FIG. 5(a) the gas flow as well as the open or closed state (marked with “c” for closed state and marked with “o” for open state) of the bypass valve 27, the input 21, e.g. an input valve 211 and the output 22, e.g. an output valve 222 prior to droplet dispensing is shown. A starting pressure is set at the gas supply 3. FIG. 5(a) is based on the embodiment represented in FIG. 4. For dispensing drop volumes an outlet port 42 of the container 4 comprises a dosing valve 10. Prior droplet dispensing starts, the dosing valve 10 is closed (marked with “c”). In an alternative (not shown in FIG. 5(a)) there is only an outlet port 42. Prior dispensing the outlet port 42 is closed. The input 21, e.g. the input valve 212 as well as the output 22, e.g. the output valve 222 are open and a gas stream enters the apparatus 1 and the container 4 with the liquid fluid 5. The input port 212′, the output port 221′ and the inlet port 41 of the container 4 are open as well. According to FIG. 5(a) the bypass valve is closed. Optionally the bypass valve can be opened briefly at the beginning to circumvent the restriction 23. The absolute pressure sensor 25 and the differential pressure sensors 24-1, 24-2 are continuously evaluated until a stable value is reached. Further the amount of gas within system and cartridge is calculated.

In FIG. 5(b) the gas flow as well as the open or closed state of the input 21, e.g. the input valve 221, the output 22, e.g. the output valve 222, the outlet port 42 of the container 4 comprising the dispensing valve 10 is shown. FIG. 5(a) is based on the embodiment represented in FIG. 4. During droplet dispensing the output 22, e.g. the output valve 222 and the bypass valve 27 are closed. No further gas enters the container 4. By repeatedly opening and closing the dosing valve 10, droplets are ejected from container 4. The differential pressure sensors 24-1, 24-2 are continuously evaluated until a pre-determined amount of droplets are dispensed and/or a pre-determined differential pressure is measured by the differential pressure sensors 24-1, 24-2.

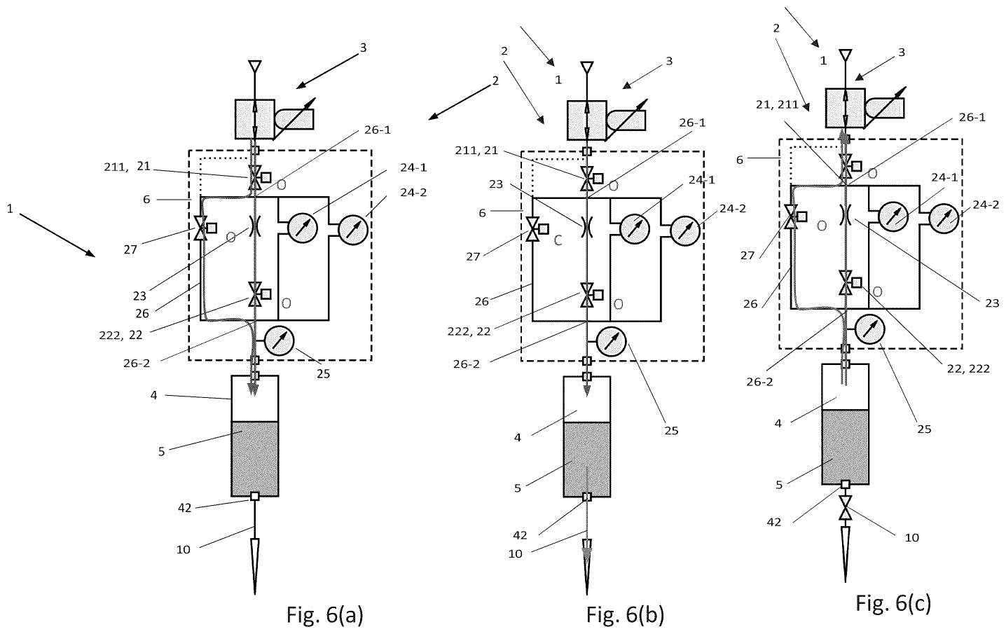

In FIG. 6(a) the gas flow as well as the open or closed state (marked with “c” for closed state and marked with “o” for open state) of the bypass valve 27, the input 21, e.g. an input valve 211 and the output 22, e.g. an output valve 222 prior to metered continuous volumetric dispensing of a liquid fluid, for example dispensing of strands, are shown. FIG. 6(a) is based on the embodiment represented in FIG. 4. Compared to droplet dispensing as shown in the previous FIGS. 5(a), (b) the outlet port 42 of the container 4 only optionally comprises a dosing valve 10. In case a dosing valve 10 is presents, it will be opened prior to metered continuous volumetric dispensing of a liquid fluid. Prior to metered continuous volumetric dispensing of a liquid fluid, for example strand dispensing, the bypass line 26 is activated by opening the bypass valve 27. Further opened are the input 21 and the output 22. A dispensing pressure is set at the gas supply 3. The absolute pressure sensor (25) or the differential pressure sensors 24-1, 24-2 are continuously evaluated until a stable value is reached.

In FIG. 6(b) the gas flow as well as the open or closed state (marked with “c” for closed state and marked with “o” for open state) of the bypass valve 27, the input 21, e.g. an input valve 211 and the output 22, e.g. an output valve 222 during metered continuous volumetric dispensing of a liquid fluid, for example strand dispensing is shown. During metered continuous volumetric dispensing of a liquid fluid, for example strand dispensing the bypass valve 27 is closed. The input 21, e.g. the input valve 211 and the output 22, the output valve 222 is open. The gas stream provided by the gas supply 3 enters the apparatus 1 and the container 4 with the liquid fluid 5. The input port 212′, the output port 221′ and the inlet port 41 of the container 4 are open as well. A gas stream enters the apparatus 1 and the container 4 with the liquid fluid 5.

The pressure difference is continuously measured over the first restriction 23 by evaluating the first 24-1 and second 24-2 differential pressure sensor. Thereby a flow of liquid fluid exiting the container 4 and being dispensed is determined.

The input is closed upon an end-of-dispensing condition being met, the end-of dispensing condition being in particular a pre-determined amount of liquid fluid being dispensed and/or a pre-determined dispensing time being reached (not shown in FIG. 6(b)). Venting of the container 4 after metered continuous volumetric dispensing of a liquid fluid, see FIG. 6(c).

In FIG. 6(c) the gas flow as well as the open or closed state (marked with “c” for closed state and marked with “o” for open state) of the bypass valve 27, the input 21, e.g. an input valve 211 and the output 22, e.g. an output valve 222 after metered continuous volumetric dispensing of a liquid fluid, for example strand dispensing. The input 21, e.g. the input valve 211 and the output 22, the output valve 222, the bypass valve 27 are open. The input port 212′, the output port 221′ and the inlet port 41 of the container 4 are open as well. A remaining gas stream captured in the container 4, leaves the container via the inlet port 41, enters the pressure control unit 2 via the output port 221′. Due to the opened output 22, e.g. the output valve 222, the opened bypass valve 27 and the opened input 21, e.g. the input valve 211 the gas stream flowing through the pressure control unit. Via an open input port 212′ the gas stream enters the gas supply 3.

The embodiment shown in FIG. 6(c) is based on the embodiment of FIG. 4. The outlet port 42 of the container comprises a dosing valve 10. For metered continuous volumetric dispensing of a liquid fluid, for example strand dispensing, the dosing valve 10 is optional.

### REFERENCE SIGNS

1 apparatus
2 pressure control unit
21 input
211 input valve
22 output
222 output valve
212, 212′ Input port
221, 221′ output port
23 first restriction
24-1 first differential pressure sensor
24-2 second differential pressure sensor
25 absolute pressure sensor
26 bypass line
26-1 first end
26-2 second end
27 bypass valve
28 second restriction
3 gas supply
4 container
41 inlet port of the container
42 outlet port of the container
5 liquid fluid
6 housing
61 internal space
7 vent valve
8 vent silencer
9 additional flow channel
10 dosing valve
p1 auxiliary pressure
p2 gas volume determination pressure
p3 dispensing pressure
p4 starting pressure

1. An apparatus for metered continuous volumetric dispensing of a liquid fluid, the apparatus comprising:
a pressure control unit; and
a gas supply,
the gas supply providing a controllable gas stream,
the pressure control unit comprising an input and an output, wherein the input is configured to be fluidically coupled with the gas supply and wherein the output is configured to be fluidically coupled with an inlet port of a container, the pressure control unit further comprising a first restriction fluidically arranged between the input and the output,
the pressure control unit further comprising: at least one first differential pressure sensor for measuring a pressure difference over the first restriction and the output, the pressure control unit further comprising: a bypass line with a bypass valve, the bypass valve is configured to be open or to be closed, wherein the bypass line has a first end connected to the input and has a second end connected to the output, wherein the bypass line is con-figured to provide a direct fluidic connection between the input and the output, when the bypass valve is open.

2. The apparatus according to claim 1, wherein the pressure control unit further comprising a housing with an internal space.

3. The apparatus of claim 2, wherein the internal space is designed to be gas-tight.

4. The apparatus according to claim 3, the pressure control unit further comprising a second restriction, fluidically arranged between the input and the output.

5. The apparatus according to claim 4, wherein an outlet of the first restriction and an inlet of the second restriction are configured to be fluidically coupled to the internal space of the housing.

6. The apparatus according to claim 2, wherein a first port of the first differential pressure sensor is fluidically coupled to an inlet of the first restriction and a second port of the first differential pressure sensor is fluidically coupled to the internal space of the housing.

7. The apparatus according to claim 2, wherein the pressure control unit comprising a second differential pressure sensor, wherein a first port of the second differential pressure sensor is fluidically coupled to an outlet of the second restriction and a second port of the second differential pressure sensor is fluidically coupled to the internal space of the housing.

8. The apparatus according to claim 1, wherein a first port of the first differential pressure sensor is fluidically coupled to an inlet of the first restriction and a second port of the first differential pressure sensor is fluidically coupled to an outlet of the output.

9. The apparatus according to claim 8, the pressure control unit further comprising a second differential pressure sensor, wherein the second differential pressure sensor is fluidically arranged in parallel to the first differential pressure sensor.

10. The apparatus according to claim 7, wherein the first and second differential pressure sensor have different measurement ranges.

11. The apparatus according to claim 2, wherein the apparatus further comprising a vent valve, which fluidically coupled to the internal space of the housing with one end and to a surrounding atmosphere with the second end, preferably the second end is fluidically coupled to a vent silencer.

12. The apparatus according to claim 1, wherein the apparatus further comprising a vent valve, wherein one end of the vent valve is configured to be coupled to the container and the second end to a surrounding atmosphere.

13. The apparatus according to claim 12, the apparatus comprising an additional flow channel for coupling the vent valve with the container, whereby said flow channel bypasses among others an outlet of the output.

14. The apparatus according to claim 1, wherein the input comprises an input port and/or an input valve for fluidically coupling the pressure control unit to the gas supply and the output comprises an output port and/or an output valve for fluidically coupling the pressure control unit to the container.

15. The apparatus of claim 1, wherein the pressure control unit further comprises an absolute pressure sensor for measuring the absolute pressure in the pressure control unit.

16. The apparatus of claim 1, wherein the container for carrying a liquid has an outlet port, preferably the outlet port is coupled to a needle or a dosing valve.

17. The apparatus according to claim 1, wherein the apparatus is configured for metered dispensing of drop volumes of a liquid fluid.

18. A method for metered continuous dispensing of liquid fluid with the apparatus according to claim 1, the method comprising steps of:
i. setting a dispensing pressure at the gas supply,
ii. opening the input, the output, and the bypass valve,
iii. continuously evaluating an absolute pressure sensor or the differential pressure sensors until a stable value is reached,
iv. closing of the bypass valve,
v. continuously measuring of the pressure difference over the first restriction or over the first and second restriction by evaluating the first and second differential pressure sensor, thereby determining a flow of liquid fluid exiting the container and being dispensed,
vi. closing the input upon an end-of-dispensing condition being met, the end-of-dispensing condition being in particular a pre-determined amount of liquid fluid being dispensed and/or a pre-determined dispensing time being reached.

19. The method according to claim 18, wherein a pre-determined target is achieved, the container and/or an internal space of a gas-tight housing is vented.

20. The method according to claim 19, wherein venting takes place by opening the output and a vent valve, whereby the vent valve is fluidically coupled to the internal space of the housing with one end and to a surrounding atmosphere with the second end.

21. The method according to claim 20, wherein venting takes place by opening a vent valve which is fluidically coupled to the container with one end, preferably, via an additional flow channel and with the second end to the surrounding atmosphere.

22. The method according to claim 21, wherein venting takes place by opening the bypass valve, the output and the input.

23. A method using the apparatus according to claim 17, the method comprising steps of:
i. setting a starting pressure at the gas supply,
ii. opening the input and the output with the bypass valve being closed,
iii. continuously evaluating an absolute pressure sensor and the differential pressure sensors until a stable value is reached,
iv. calculating an amount of gas within system and cartridge,
v. closing the output,
vi. dispensing of liquid fluid as droplets by repeatedly opening and closing of a dosing valve and continuously evaluating the differential pressure sensors until a pre-determined amount of droplets are dispensed and/or a pre-determined differential pressure is measured by the differential pressure sensors.

24. The method according to claim 23, wherein when a pre-determined target is achieved, the container and/or an internal space of a gas-tight housing is vented.

25. The method according to claim 24, wherein venting takes place by opening the output and a vent valve, whereby the vent valve is fluidically coupled to the internal space of the housing with one end and to a surrounding atmosphere with the second end.

26. The method according to claim 24, wherein venting takes place by opening a vent valve which is fluidically coupled to the container with one end, preferably, via an additional flow channel and with the second end to a surrounding atmosphere.

27. The method according to claim 24, wherein venting takes place by opening the bypass valve, the output and the input.

28. A method for determining by the apparatus according to claim 16 an initial gas volume which is present in the container, the method including:
i. closing of the dosing valve,
ii. setting of an auxiliary pressure at the gas supply, the auxiliary pressure being defined by a gas volume determination pressure reduced by a maximum measuring pressure measurable by the differential pressure sensors,
iii. opening of the input, the output, and preferably the bypass valve, and continuously evaluating an absolute pressure sensor or the differential pressure sensors until a stable value for auxiliary pressure is reached,
iv. if applicable, closing the bypass valve
v. setting the gas volume determination pressure at the gas supply,
vi. recording of a measurement of an absolute pressure on absolute pressure sensor and a differential pressure over the first restriction or the first and the second restriction on the first and the second differential pressure sensor as function of time,
vii. computing the initial gas volume based on the recorded measurements of the absolute pressure and the differential pressure over the first restriction or the first and the second restriction on the first and the second differential pressure sensor.
